(19) United States
(12) Patent Application Publication
(10) Pub. No.: US 2009/0265188 A1
(43) Pub. Date: Oct. 22, 2009

(54) Graphical Representation of Medical Knowledge

(75) Inventors: Jean-Baptiste Lamy, Paris (FR); Catherine Cartolano Duclos, Boulogne (FR); Alain Venot, Paris (FR)

Correspondence Address: NIXON & VANDERHYE, PC, 901 NORTH GLEBE ROAD, 11TH FLOOR, ARLINGTON, VA, 22203, US

(73) Assignee: UNIVERSITE PARIS 13

(21) Appl. No.: 12/227,217

(22) PCT Filed: May 10, 2007
(86) PCT No.: PCT/EP2007/054519

§ 371 Date: Nov. 12, 2008

Related U.S. Application Data
(60) Provisional application No. 60/799,653, filed on May 12, 2006.

(51) Int. Cl. G06Q 50/00; G09G 5/02; G06T 11/20

(52) U.S. Cl. 705/3; 345/595; 345/440; 345/441

(57) ABSTRACT

The present invention relates to a method for graphical representation of medical knowledge, as well as to methods and supports using the same.

The present invention relates to a method for graphical representation of medical knowledge, as well as to methods and supports using the same.

### INTRODUCTION

Medical knowledge is growing both in quantity and complexity, and it is becoming increasingly difficult to find the right information. Most medical knowledge sources have been digitalized, but the way knowledge is presented to the user has not changed, and still relies principally on text-based approaches. According to the well-known proverb, ‘a picture is worth a thousand words’, L. S. Elting et al. [1] showed that a picture can worth a thousand of medical words. Healthcare professionals need information in different situations, each of which could benefit from graphical approaches, such as:
During a consultation: as the patient is present, the professional is stressed and lacks time but the information concerned is often simple. This situation is ideal for graphical approaches, which can reduce the volume of knowledge displayed and provide more rapid access to that knowledge.
After a consultation, to investigate a specific point in greater detail: the professional is less stressed, and the knowledge involved may be complex. A graphical approach would probably not be accurate enough to represent the complex medical knowledge, but could make it easier to find the right reference text rapidly.
In continuing education: a graphical approach could make the knowledge more accessible and attractive.

A literature review showed that several complementary approaches have been investigated in the prior art as an attempt to represent the medical knowledge.

A first approach, termed Information visualization (IV), aims to represent a given piece of information graphically, to make that information more accessible and, in some cases, to allow ‘visual data-mining’. IV focuses on abstract information with no spatial or geometric properties, and thus no obvious graphical form. Many items of medical data and knowledge are neither spatial nor geometric and fall into the field of IV: for example drug knowledge, patient characteristics and antecedents, clinical results, whereas anatomy and anatomical examinations (e.g. X rays) do not. L. Chittaro [5] reviewed the use of IV in medicine, and K. Andrews [6] has produced an almost exhaustive list of IV systems. IV relies on interactivity to involve users. Fisheye is used to generate this interactivity; it separates information into the focus (information interesting for the user) and the context (information less interesting for the user). The user interacts with the system to specify the focus and the context. The focus is then displayed in more detail than the context. There are two types of Fisheye: filtering and deforming Fisheyes. In the filtering Fisheye, the context is hidden, like in zoom-based technics. In the deforming Fisheye, a larger area of the screen surface is devoted to the focus than to the context. An example of deforming Fisheye is a 3D perspective in a virtual reality tool, in which the nearby objects are the focus and appear larger.

Other methods have been proposed using texts, including greeking and Fisheye. However, these methods either deform the text or make it unreadable. As a consequence, none of them appears to be suitable for medical texts.

2D and 3D graphics have also been widely used to display medical data for overview or monitoring purposes. An example is provided by interactive parallel bar charts (IBPC), a system designed by L. Chittaro et al. [7] for visualization of the clinical data acquired by hemodialyzer devices. However, this system is not appropriate for the representation of medical knowledge.

Object-attribute matrices have also been applied to patients (e.g. patients involved in a clinical trial), drugs and diseases. These methods essentially highlight the differences or similarities between objects. M. Spenke et al. [9] have successfully used the table lens method to display medical data, such as blood parameters, C. Wroe et al. [10] have used such methods to display a drug ontology for authoring purposes, C. Duclos [8] used tables to display antibiotic spectra, and L. S. Elting et al. [1] have evaluated the use of glyphs for monitoring purposes. While these methods are suitable to compare objects and find similarities, they do not allow a representation of complex medical knowledge.

Other methods have been disclosed to present trees and networks (I. Herman et al. [11]; B. Ketan [12]) and similarity indices, which could be applied to medical information. However, none of these approaches allows a clear representation of medical knowledge.

Methods based on graphical languages are found everywhere today, from traffic signs to computer software icons and modeling (unified modeling language, UML). As simple as they seem, these languages are governed by the complex rules of semiotics, the science of signs and sign systems. Graphical languages have several advantages over textual languages:
They tend to be universal. They can be understood without learning by analogy: words have arbitrary meanings, but we can guess the meaning of pictures of concrete things.
They are also independent of native languages, although it is difficult to achieve complete independence from cutural background.

They are more concise and more attractive to the eye than text, and can be read faster. Under certain circumstances that allow pre-attentive perception, it is possible to search items in a picture very rapidly (<200 ms), regardless of the number of items [2].

However, graphical languages have drawbacks: they are less precise than native textual languages, and they often have greater technical requirements such as color printing or animated display. Graphical languages are therefore most appropriate for simple information that must be understood rapidly or universally. For example, chemical product labeling focuses on universal understanding, as everyone must be able to understand the labels, whereas traffic signs focus on the rapid transmission of information, as trained drivers must be able to assimilate the information conveyed by traffic signs as rapidly as possible.

In the medical field, some graphical approaches exist. A pictogram set has been proposed by the United States Pharmacopeial Convention (USP) for drug patient leaflets [3]. This language involves simple information, conveyed in a fashion that can be understood by everyone, using iconic pictures and few, if any grammatical structures. More specifically, these pictograms deal with dose planning, adverse effects, administration route, safe practices for administration, drug storage, interactions with food, contraindications, etc. However, the pictograms are in black and white and are followed by a sentence in English.

Stabilis 2 [4] is a database related to the stability and compatibility of injectable drugs. For each drug, Stabilis 2 provides information concerning the therapeutic classification, storage, stability in various solutions, incompatibilities, etc. Stabilis 2 uses a pictogram set, with no grammatical structure.

A medical graphical language has been proposed by B. Preiss et al., called UVAL-MED [AMIA, Inc., 1994]. This language proposes grammatical rules in addition to pictograms, in order to combine the various pictograms. However, UVAL-MED is limited to diseases and symptoms, and it has not been designed for fastening the reading of medical documents, but for help understanding and memorizing physiopathology of diseases.

Accordingly, while methods have been proposed for the graphical representation of knowledge, these methods essentially follow an ‘intuitive approach’ rather than a rational approach, do not take into account semiotics and the abilities of human visual perception, and do not allow a simple and precise representation of medical knowledge.

As a result, there is a clear need for rigorous methodology to represent graphically medical knowledge.

### SUMMARY OF THE INVENTION

The present invention discloses a novel method for representation of medical knowledge and uses thereof. More specifically, the invention results from the creation of a new graphical language based on semiotics, information vizualisation and grammatical structures, allowing a clear and simple representation of complex medical knowledge, with no need for added text.

More specifically, the invention relates to a method for graphical representation of medical knowledge, the method comprising the building of icons using pictograms, colors and shapes and, optionally, using entire icons, according to a grammar, thereby composing a language representing patient's states, including e.g., diseases and patient lifestyles, risks of disease, drugs, follow-up procedures, contra-indications, safe practices and/or adverse effects.

A further aspect of this invention relates to a computer software or hardware comprising a set of pictograms, colors and shapes to compose a language representing medical knowledge as described above.

The invention also relates to a medical drug dictionary, wherein said dictionary comprises a graphical representation of drugs' profile, said graphical representation comprising a set of pictograms, colors, shapes and a grammar to compose a language representing patient's states, including e.g., diseases and patient lifestyles, risks of disease, drugs, follow-up procedures, contra-indications, safe practices and/or adverse effects. In a specific embodiment, the drug dictionary allows to view the properties of one drug, but also to compare several drugs.

A further object of this invention is a medical document, such as a clinical guideline, an education program or a medical textbook, wherein said document comprises a graphical representation of the medical knowledge, said graphical representation comprising a set of pictograms, colors, shapes and a grammar to compose a language representing patient's states, including e.g., diseases and patient lifestyles, risks of disease, drugs, follow-up procedures, contra-indications, safe practices and/or adverse effects.

Another aspect of the invention is a method to index a medical document by a graphical interactive stylised and schematized character, wherein said character is divided into several locations, each of them being dedicated to an anatomico-functional localisation or an etiology represented e.g., by a VCM icon.

Another aspect of the invention resides in a search engine that displays the results of the search using an iconic language representing medical knowledge as described above, by combining a set of pictograms, colors and shapes. In a specific embodiment, the interface of the search engine also uses a character as described above.

Another aspect of this invention resides in a medical patient record, wherein said medical patient record comprises a graphical representation of the patient current or past state, said graphical representation comprising a set of pictograms, colors, shapes and a grammar to compose a language representing patient states, including e.g., diseases and patient lifestyles, risks of disease, drugs, follow-up procedures, contra-indications, safe practices and/or adverse effects. In a specific embodiment, the record also uses a character as described above.

Another aspect of this invention resides in a system for helping to encode medical data according to a terminology, or a system for viewing, browsing and navigating in a medical terminology, wherein said system comprises the use of an iconic language representing the various terms, including e.g., diseases and patient lifestyles, risks of disease, drugs, follow-up procedures, contra-indications, safe practices and/or adverse effects. In a specific embodiment, the system also uses a character as described above.

A further aspect of this invention is the application of the drug dictionary, the medical document, the indexing, the search engine, the patient record or the system for using or viewing medical terminologies described above on a PDA (Personal Digital Assistant).

### LEGEND TO THE FIGURES

FIG. 1: Building icons from colors, shapes and pictograms in VCM

FIG. 2: Example of VCM icons and sentences

FIG. 3: List of pictograms and shapes

FIG. 4: Mister VCM

### DETAILED DESCRIPTION OF THE INVENTION

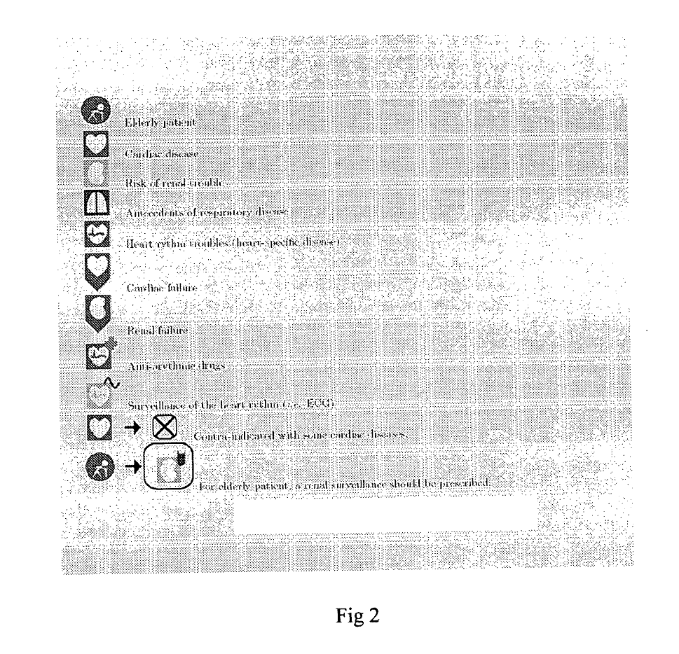

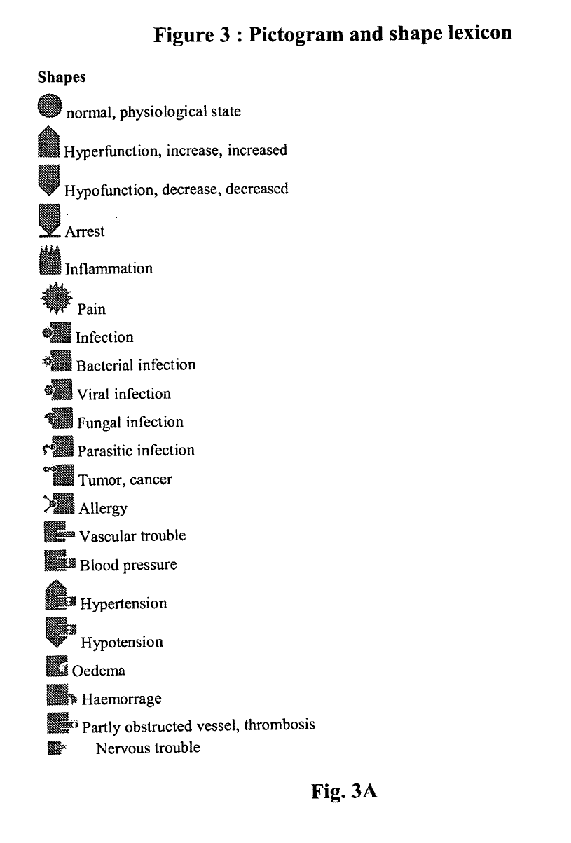

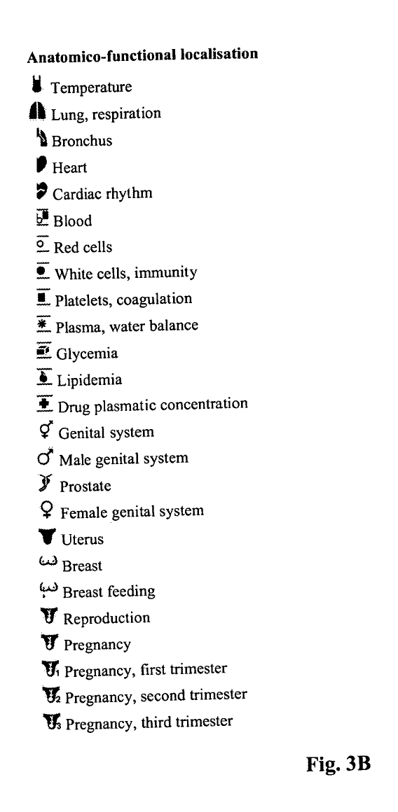

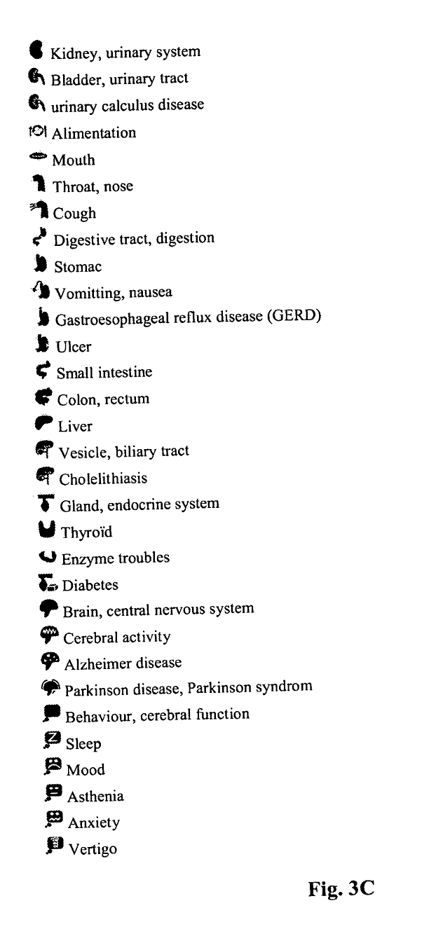

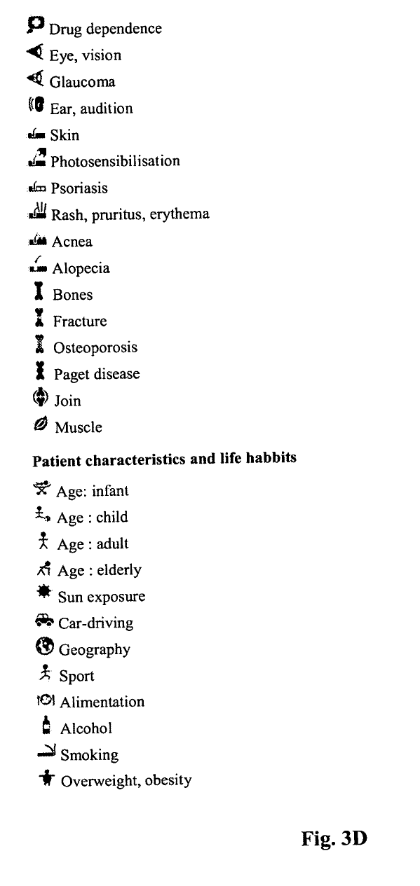

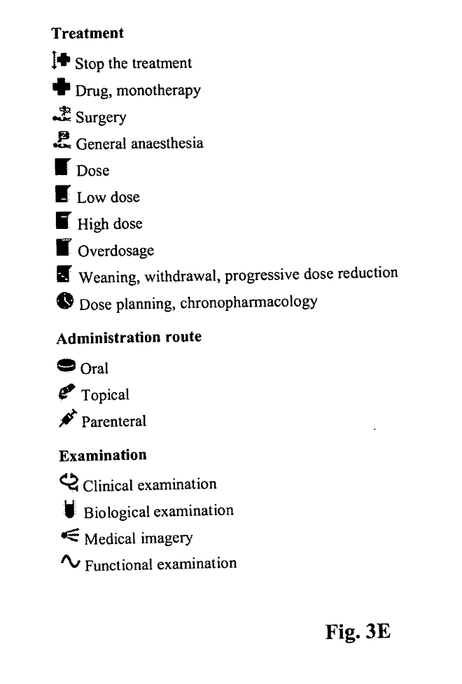

The invention discloses a novel graphical language for representing medical knowledge. VCM (Visualisation des Connaissances Médicales, Medical Knowledge Visualization) has been applied to drug knowledge, such as the Summary of Product's Characteristics (SPC) and the therapeutic parts of clinical guidelines (CG). The intended users are health professionals, such as physicians, pharmacists, nurses, etc. VCM relies on solid cognitive and semiotic bases. It typically includes a set of pictograms (see FIG. 3) to represent e.g., anatomical sites, etiologies, pharmacological targets, together with a simple grammar to combine these pictograms and build icons such as disease or drug pictograms, and then sentences concerning contraindications, adverse reactions, and so on (see FIG. 2).

VCM has been designed to extend textual language but not to replace it, as it cannot achieve a similar level of precision. For example, VCM essentially uses generic concepts, such as ‘chronic obstructive lung disease’, rather than specific conditions, such as ‘asthma’, determined with the inheritance relations of medical classifications such as the International Classification of Diseases (ICD10).

### 1 VCM Icons

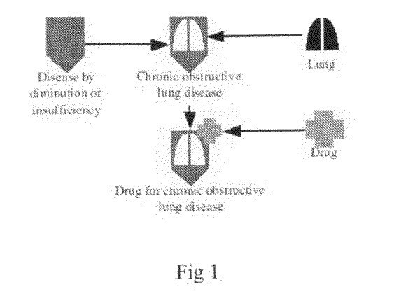

VCM is a graphical language made of icons whose generation is based on a graphical grammar (see e.g., FIG. 1). These icons represents e.g. diseases, risks, drug treatments or follow-up procedures. Using another grammar, icons can be combined to make graphical sentences expressing e.g. contra-indications, drug interactions, warnings, safe practices or adverse effects.

### 1.1 Patient States

Patient states includes diseases, symptoms, physiological states (e.g. pregnancy), lifestyle (e.g. alcohol consumption), as well as the eventual associated medical management. Patient states are described by four attributes:
the type of patient state,
zero or more disorders,
the eventual patient characteristic, life habit or body part where the disorders (or the absence of disorder) is located,
the eventual medical management undertaken to treat the patient state.

Depending on their temporal location and their uncertainty, the type of patient state can be:
an antecedent (past state),
a current state,
a risk of a future state.

VCM distinguishes two categories of disorders. Specific disorders are specific to the patient attribute, e.g. cough (specific to throat). Generic disorders are not, e.g. failure (which can be applied to heart, kidney, lung, . . . ). The most basic disorder is the generic “abnormal/pathological” disorder. More precise disorders (generic or specific) are:
a variation: increase, decrease, stop, . . .
an etiology: bacterial infection, allergy, . . .
a pathological process: inflammation, vascular disorder, . . .
a symptom: pain, . . .

The patient characteristic, life habit or body part can be:
a patient characteristic, e.g. age,
a patient life habit, e.g. alcohol consumption,
an anatomico-functional localisation, e.g. heart or lung/respiratory system,
a precise function, related to a given anatomico-functional localisation, e.g. heart rhythm (related to heart),
a precise anatomic localisation, related to a given anatomico-functional localisation, e.g. bronchus or throat (related to respiratory system),

VCM considers two types of medical management:
a drug treatment, which can be precised by the administration route, e.g. oral; VCM usually specifies the administration route only when it is pertinent, or when it allows to distinguish therapeutical classes (e.g. oral antidiabetes drug vs insuline).
a follow-up procedure, which can be precised by the method of examination, e.g. biology or imagery.

### 1.2 Drug Treatments and Follow-Up Procedures

Drug treatments and follow-up procedures are primarily described by their indications (e.g. a current diseased patient state for a drug treatment, a risk for a follow-up procedure). A drug treatment or a follow-up procedure for a patient state X is considered as the same than patient state X treated by a drug, or followed by a follow-up procedure. As a consequence, drug treatments and follow-up procedures are actually handled as patient states.

### 1.3 Medical Actions

VCM considers two kinds of medical actions:
the start of a new medical management for treating a given patient state,
a modification of the current medical management, e.g. stop the treatment, increase the dose, . . .

A modification of the current medical management is described by:
the type of medical management (drug treatment or follow-up procedure, see above),
the medical management characteristic modified, e.g. the dose for a drug treatment,
the variation applied to the medical management attribute, i.e. modified, increased, decreased, stopped.

VCM doesn't indicate which medical management is involved by the modification. However, the context often makes it obvious.

### 1.4 Description of VCM Icons

A VCM icon has 3 parts:
an external shape,
an optional central white pictogram, inside the shape,
an optional top-right pictogram.

The icon has five modifiable attributes:
the shape
the color of the shape
the central pictogram
the top-right pictogram
the color of the top-right pictogram

### 1.5 VCM Grammar

### 1.5.1 Color Underlying Concepts

VCM provides 5 colors which identify the various types of patient states and medical management:
brown, for past patient states, corresponding to the notion of antecedents,
red, for current patient states,
orange, for future possible patient states, corresponding to the notion of risk,
green, for treatments,
blue, for follow-up procedures.

The color of the shape is brown, red or orange for icons representing patient states (respectively a past, current and possibly future state), and green or blue for icons representing a change to a medical management (respectively a change to a treatment and a medical procedure).

When the top-right pictogram is present, its color indicates the type of medical management associated to a patient state: green for a treatment and blue for a follow-up procedure.

### 1.5.2 Shape Underlying Concepts

The shape of the icon represents the eventual disorders (for patient states) or the variation (for modifications to an existent medical management). The shape is divided in two parts: a basic shape and zero or more shape modifiers that are added to the basic shape.

Basic shapes describe whether the icon deals with a physiological related state, i.e. there is no disorder, or a pathological related state, i.e. there are some disorders. Pathological related states include diseases, symptoms, diseases treated by a drug treatment, . . . . For physiological related state, the basic shape is a circle, and for pathological related state, it is a square.

Figures of basic shapes:

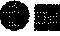

Shape modifiers give more details than the basic shape. They describe general concepts that can be applied to more than one state: generic disorders (for patient states) or variations (for modifications to an existent medical management). Among these shape modifiers we can distinguish:
a general anatomical localisation (such as vascular, neurological),
a general physiopathological process that can be:
   a variation (such as hyperfunction, hypofunction, stop),
   an external agents (such as virus, bacteria),
   an haemorrhage or an oedema,
   a cancer,
   an inflammation,
a general symptom (such as pain), a general treatment modifier that can be:
   a variation (such as an increase, a decrease, a stop).

For shape modifiers expressing a general anatomical localisation, a schematic drawing of this localisation is representing going out from the square on the right side (e.g: a neurological localisation can be represented by a neuron, vascular localisation by a vessel).

Figures of shape modifiers for general anatomical localisation:

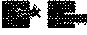

(Notice: the figure represent the shape modifier applied to a square, not just the shape modifier alone. The figure is in red, but only the shape does matter here, as the color has a specific meaning; however we cannot represent a shape without giving it an arbitrary color. This notice applies also to all following figures in this section).

Shape modifiers expressing a variation are represented by triangles pointing up (meaning increase), pointing down (meaning decrease) or pointing down to an horizontal line (meaning stop).

Figures of shape modifiers for variation:

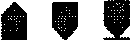

For shape modifier expressing etiologies involving external agents, microbiological aspect of the agents is used, except for fungi that are represented as mushrooms using semantic analogy. The agent is represented entering inside the square, by the left side.

Figures of shape modifiers for etiology:

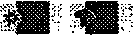

For shape modifiers expressing an haemorrhage or an oedema, a schematic representation of liquid flow are used, on the right side of the square.

Figures of shape modifiers for haemorrhage and oedema:

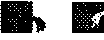

For shape modifiers expressing a cancer, the mathematical symbol of infinity is used (analogy with the infinite division of cells, the symbol also looks like two cells in division).

Figure of shape modifiers for cancer:

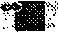

The inflammation shape modifier is represented by a set of flames (semantic analogy with the fire).

Figure of shape modifiers for inflammation:

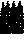

The pain shape modifiers is symbolized by a set of thorns.

Figure of shape modifiers for pain:

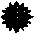

### 1.5.3 Central Pictogram Underlying Concepts

Central pictograms in VCM are drawings representing patient characteristics, life habits, anatomico-functional localisations, specific disorders, and medical management modifiable characteristics (non modifiable characteristics being represented by the top-right pictogram). About 100 central pictograms exist in VCM.

For patient state icons, the central pictogram can represent:
the anatomico-functional localisation of the disorders (or absence of disorder) such as cardiac disease, respiratory disease. In this case, the underlying organ is stylized (e.g. heart, lung).
Figures of VCM icons with a central pictogram representing anatomico-functional localisations:

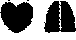

the anatomico-functional localisation of the disorders AND the localisation-specific disorders associated. In this case, the central pictogram is the pictogram of the anatomico-functional localisation, which is modified or enriched in order to represent also the physiopathology or the symptoms of the disorders (e.g. an ECG signal in a heart to represent the disorder of cardiac rhythm (physiopathology), or expectoration coming from the throat to represent the cough (symptom)).
Figures of VCM icons with a central pictogram representing anatomico-functional localisations and specific disorders:

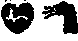

The physiological patient characteristics include:
age, in this case, central pictograms represent the various stages of life,
sex, in this case the conventional symbol of male and female is used,
pregnancy,
breasting.

The life habits are related to food and alcohol consumption, smoking, sport, driving, travelling, sun exposition . . . . In this case, objects commonly associated to the habit are used (e.g. a wine bottle for alcohol consumption, a cigarette for smoking).

The medical management modifiable characteristics include:
the level of dosage of a drug. In this case, the central pictogram is a measuring jug, and various marks are added on it to specify the level of dosage (low, high and overdose).
the other characteristics such as planning are also represented by commonly associated objects (e.g.: a clock for planning).

### 1.5.4 Top-Right Pictogram Underlying Concepts

Only patient state icons can have top-right pictograms. When present, the top-right pictogram represents the medical management associated to a patient state. The top-right pictogram's color indicates the type of medical management associated to a patient state: green for a treatment and blue for a follow-up procedure.

The top-right pictogram itself specifies the medical management:
for drug treatments, it represents the administration route by the drug form or by a symbol (a pomade tube for local drugs, a tablet for oral drugs, a syringe for injectable drug, or a cross if administration route is not specified).
for follow-up procedures, it represent the examination method, such as biology or imagery. In this case objects symbolizing the monitoring characteristic are used (e.g. a test tube to symbolize the biological monitoring).

Figures of examples of VCM icon representing a drug treatment and a follow-up procedure:

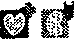

### 1.5.5 Combinatory

VCM icons are built by combining up to 5 elements, corresponding to the 5 modifiable attributes of the icon.

A patient state icon is built by combining:
a shape color, that indicates the type of state (past, current or possibly future),
a shape, possibly modified by one or more shape modifiers, that indicates the eventual generic disorders,
optionally, a central pictogram that indicates the patient characteristic, life habit, or anatomico-functional localisation, as well as localisation-specific disorders,
optionally, a top-right pictogram that indicates the medical management associated to the patient state:
   the top-right pictogram color, that indicates the type of medical management (treatment or follow-up procedure),
   the top-right pictogram itself, that indicates the administration route (for treatment) or the examination method (for follow-up procedure).

A modification of the current medical management icon is built by combining:
a shape color, that indicates the type of medical management (treatment or follow-up procedure),
a shape, possibly modified by one or more shape modifiers, that indicates the modification (e.g. increase),
a central pictogram that indicates the medical management characteristic that is modified (e.g. dose).

### 1.5.6 Examples of Valid Combinations

VCM grammar is defined by the combination rule given in the previous section. The rules given here are just examples of valid combinations, often commonly used; however any icon that satisfies the combination rules above is a valid VCM icon.

### Icons of Pathological Related Situations

pathological related situation: square.

### Diseases and Symptoms

Icon of a current disease: red square.

Icon of a past pathology (also called antecedent of pathological situation): brown square.

Icon of a possible future pathology (also called risk of pathological situation): orange square.

Icon of {current, past, possible future} pathology with a specific disorder: {red, brown, orange} square, with the inclusion in its center of the pictogram of the disorder and the corresponding anatomico-functional localisation in white.

Icon of {current, past, possible future} pathology caused by an excess of life habits: {red, brown, orange} square, with the inclusion in its center of the pictogram of life habit in white.

Icon of {current, past, possible future} pathology with general anatomical localisation: {red, brown, orange} square with the inclusion on the right side of the general anatomical localisation shape modifier in {red, brown, orange}.

Icon of {current, past, possible future} pathology with an external agent: {red, brown, orange} square with the inclusion on the left side of the external agent shape modifier in {red, brown, orange}.

Icon of {current, past, possible future} pathology with hyperfunctionning: {red, brown, orange} square with the juxtaposition on its up side of the increase shape modifier in {red, brown, orange}.

Icon of {current, past, possible future} pathology with hypofunctionning: {red, brown, orange} square with the juxtaposition on its down side of the decrease shape modifier in {red, brown, orange}.

Icon of {current, past, possible future} pathology with arrest: {red, brown, orange} square with the juxtaposition on its down side of the stop shape modifier in {red, brown, orange}.

Icon of {current, past, possible future} pathology with inflammation: {red, brown, orange} square with the juxtaposition on its top side of the inflammation shape modifier in {red, brown, orange}.

Icon of {current, past, possible future} pathology with pain: {red, brown, orange} square with the juxtaposition all around it of the pain shape modifier in {red, brown, orange}.

Icon of a current pathology under therapeutic management: red square with the inclusion on the right top corner of the pictogram of a type of therapeutic management in green.

Icon of a current pathology under therapeutic management with a mention of the type of action: red square with the inclusion on the right top corner of the pictogram of a form in green.

Icon of a future pathology under monitoring management: orange square with the inclusion on the right top corner of the pictogram of a type of monitoring management in blue.

### Treatment

Icon of a specific drug: it is described by its indication, it is thus a pathology treated.

Icon of treatment characteristic: green square with the with the inclusion in its center of the pictogram of the treatment characteristic in white.

Icon of treatment characteristic with increase: green square with the juxtaposition on its up side of the increase shape modifier in green.

Icon of treatment characteristic with decrease: green square with the juxtaposition on its down side of the increase shape modifier in green.

Icon of treatment characteristic with stop: green square with the juxtaposition on its down side of the stop shape modifier in green.

### Monitoring

Icon of a specific monitoring: it is described by its indication, it is thus described as a future pathology monitored

Icon of monitoring characteristic: blue square with the with the inclusion in its center of the pictogram of the monitoring characteristic in white.

### Physiological Related Situations

Icon of a current physiological related situation: red circle.

### Physiological States

Icon of a {current, past, possible future} physiological state with a specific physiological characteristics of the patient: red circle with the inclusion in its center of the pictogram of the physiological characteristics of the patient in white.

### Life Habits

Icon of a {current, past, possible future} a life habit: {red, brown, orange} circle with the inclusion in its center of the pictogram of the life habit in white.

### 1.5.7 Generalisation

A more general VCM icon can regroup several more specific icons, e.g. the icon for “patient sufferring from cardiac disease” can regroup the icon for “patient sufferring from rhythm cardiac disease” and “patient sufferring from cardiac failure”. In this case, a shadow is added behind the general icon; this shadowed icon can read be “several cardiac diseases”.

Figure of an example of generalized VCM icon

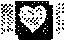

### 2 VCM Sentences

VCM can represent sentences including conditions, statements and actions, in order to express e.g. contra-indications, drug interactions, warnings, safe practices or adverse effects.

### 2.1 Medical Sentences

VCM medical sentences are composed of four parts:
the conditions, which indicates the necessary elements to make the sentence true, e.g. “if patient suffers from hypertension, then”,
the statements, which states a some information, e.g. a SPC may state that “there is a risk of renal troubles” (adverse effect), or a medical record may state that “the patient suffers from hypertension”,
the actions, which indicates medical actions; VCM distinguishes two kind of medical actions:
   the action to do, which indicates the medical actions the physician should do,
   the action not to do, which indicates the medical actions the physician should not do.

In a given sentence, any of the four parts can contain zero or more patient states or medical actions, linked with logical operator such as AND or OR. Several logical relations may be folded, e.g. “an elderly patient AND (a patient sufferring from renal failure OR a patient sufferring from hypertension)”. A NOT logical operator can also be applied to an icon to negate the icon, e.g. the negation of “patient sufferring from hypertension” is “patient not sufferring from hypertension”.

When representing SPCs or drug-based recommendations, VCM always consider that taking the drug described by the SPCs is an implicit condition. As a consequence, this condition is not taken into account nor represented graphically.

### 2.2 VCM Sentence Grammar

Sentences follow a general model. Condition are represented first, then followed by a right arrow, then followed by actions not to do, then followed by statements, and finally followed by actions to do.

Figure showing the general model:

[symbol]

### 2.2.1 Logical Operators

Logical AND is represented by juxtaposing horizontally several icons or elements, with a little gap between them. Logical OR is represented either by juxtaposing horizontally several icons separated by vertical bars, or by writing each possible alternative on a different a line. The first case corresponds to the standard convention of using “|” (a vertical bar) for OR relations, and the second case to the analogy of “derivation” (e.g. on electric schema).

Logical NOT (negation) is represented by striking the corresponding icon.

Figure for logical NOT:

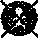

(the icon used in figures described logical relations are arbitrary and are not part of the representation of the relation)

### 2.2.2 Conditions

Conditions are followed by a right arrow, and the arrow is followed by the condition's consequence.

When there is no condition, the arrow can be hidden, but that is not an obligation. Logical relation can be included in conditions. If two or more conditions must co-occur for the sentence to be true, it is an AND relation. If two or more conditions can make the sentence true, it is an OR relation. VCM can represent conditions of the form “if (A and B and . . . ) or (C and D and . . . ) or . . . , then . . . ”, i.e. an OR relation containing several AND relations. As stated above, AND relations are represented by juxtaposing horizontally several icons. The OR relation is represented by writing each alternative of the OR relation on a different line; each line is followed by an arrow and a vertical line join the arrows at their end.

Figure for logical AND:

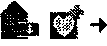

Figure for logical OR:

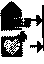

Figure for logical OR containing a logical AND:

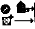

### 2.2.3 Statements

A statement is represented by the icon of the effect or property, without any decoration. Statements can include AND relation, using the form “A and B and C and . . . ”. In this case, the icons are juxtaposed horizontally, with a little gap between them.

Figure for logical AND:

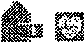

### 2.2.4 Actions

Actions to do and actions not to do are separated and located at a different place in the sentence (see above). Action are surrounded (by a black square with round corners). In addition, action not to do are striken (by a black cross).

Logical relation can be included in actions. VCM can represent actions of the form “do ((A and B and . . . ) or (C and . . . ) or . . . ) and ((D and E and . . . ) or (F and . . . ) or . . . ) and . . . ”, i.e. an AND relation containing OR relations, themselves containing AND relations. Inner AND relations are represented by juxtaposing horizontally several icons. The OR relations are represented by juxtaposing horizontally the resulting icon groups, separated by vertical bars. The outer AND relation is represented by surrounding separately each of its operand.

Figure for logical AND:

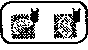

Figure for logical OR:

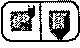

Figure for logical AND containing a logical OR containing itself a logical AND:

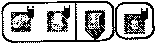

### 3 ‘Mister VCM’

Mister VCM is an extension of the VCM language. It aims to synthesize the medical knowledge on a picture that looks like a body. Some particular rules are used to generate Mister VCM's picture and body. The principle of this representation is to place on mister VCM gray locations colored icons of diseases or treatments.

Mister VCM is a method to index a medical document by a graphical interactive stylised and schematized character. This character is divided in several locations, each of them being dedicated to an anatomico-functional localisation or an etiology, represented by a pictogram. The various patient states involved in the document are represented by their VCM icons, at the corresponding location of the character.

When more than one icon needs to be located on a precise location of Mister VCM, the generalization process is used in order to generate a single, more general, icon. It aims to create a more general icon containing all of the shared graphical attributes of the specialized icons. To signal that the generate icon is a generalized one, a shadow is drawed under. When no icon is located on a given location of Mister VCM, it is represented by a grayed pictogram (with no shape around it).

Mister VCM can be used for an interactive display. In this case, the user can click on the character to display or access the related parts of the document.

### 3.1 Description of the Mister VCM Silhouette

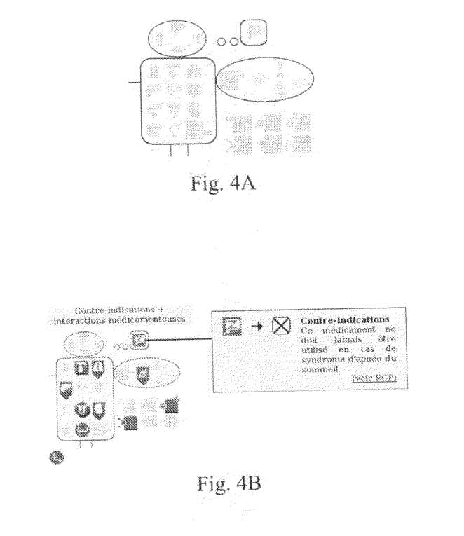

As represented on FIG. 4, Mister VCM has a silhouette composed of:
a head made of a circle,
a body made of a round corners rectangle,
a right arm made of an ellipse,
mind/thought made of a round corners rectangle for related to the head by two little circles,
a left arm made of a horizontal line and two legs made of vertical lines, which are just present in order to have body shape, but don't contain icons.

Inside Mister VCM silhouette are placed the various icons corresponding to anatomico-functional localisations or etiologies:
in the head, the following icons are found: central nervous system, ear, eye, mouth
in the body, the following icons are found: stomach, liver, intestine, colon, glandular system, blood, uterus, genitals, lung, heart, kidney, and vascular system
in the arm, the following icons are found: nervous system, muscle, bone, joint and skin
in the mind, the psychological icons are found
outside of the silhouette, under the arm, the icons for etiologies are found: bacterial infection, viral infection, fungic infection, parasitic infection, immunologic reaction, cancer.

FIG. 4A illustrates Mister VCM empty.

FIG. 4B illustrates Mister VCM representing some contra-indications.

As disclosed above, the invention may be used to represent medical knowledge in a variety of contexts and supports, such as electronic supports, paper supports, drug leaflet, educational programs, drug administrations documentations, internet, PDA (Personal Digital Assistant), etc.

In this respect, a specific object of this invention resides in a computer software or hardware comprising a set of pictograms, colors and shapes to compose a language representing medical knowledge.

Another aspect of the invention is a method to index a medical document by a graphical interactive stylised and schematized character. This character is divided into several locations, each of them being dedicated to an anatomico-functional localisation or an etiology, represented by a pictogram. The various patient states involved in the document are represented by their VCM icons, at the corresponding location of the character. When several patient states are evocated by the document for the same anatomico-functional localisation or etiology, they are represented by a single, more general, icon. When no patient states are evocated by the document for a given anatomico-functional localisation or etiology, it is represented by a grayed pictogram. The user can click on the character to display or access the related part of the document.

A further aspect of this invention resides in a medical drug dictionary, wherein said dictionary comprises a graphical representation of drugs' profile, said graphical representation comprising a set of pictograms, colors, shapes and a grammar to compose a language representing patient states, including diseases and patient lifestyles, risks of disease, drugs, follow-up procedures, contra-indications, safe practices, adverse effects, . . . and possibly using a graphical character as described above. In a specific embodiment, the drug dictionary allows to view the properties of one drug, but also to compare several drugs.

A further aspect of this invention resides in a medical patient record, wherein said medical patient record comprises a graphical representation of the patient current or past state, said graphical representation comprising a set of pictograms, colors, shapes and a grammar to compose a language representing patient states, including e.g., diseases and patient lifestyles, risks of disease, drugs, follow-up procedures, contra-indications, safe practices and/or adverse effects, and possibly using a graphical character as described above.

A further object of this invention is a medical document, such as a clinical guideline, an education program, a medical textbook, . . . , wherein said document comprises a graphical representation of the medical knowledge, said graphical representation comprising a set of pictograms, colors, shapes and a grammar to compose a language representing patient states, including diseases and patient lifestyles, risks of disease, drugs, follow-up procedures, contra-indications, safe practices, adverse effects, . . . and possibly using a graphical character as described above.

Another aspect of the invention resides in a search engine that displays the results of the search using an iconic language representing medical knowledge as described above, by combining a set of pictograms, colors and shapes. In a specific embodiment, the interface of the search engine also uses a character as described above.

Another aspect of this invention resides in a system for helping to encode medical data according to a terminology, or a system for viewing, browsing and navigating in a medical terminology, wherein said system comprises the use of an iconic language representing the various terms, including e.g., diseases and patient lifestyles, risks of disease, drugs, follow-up procedures, contra-indications, safe practices and/or adverse effects. In a specific embodiment, the system also uses a character as described above.

A further aspect of this invention is the application of the drug dictionary, the medical document, the indexing, the search engine, the patient record or the system for using or viewing medical terminologies described above on a PDA (Personal Digital Assistant).

VCM has been evaluated over a set of physicians. The objective was to determine whether using VCM instead of text, physicians answer to clinical questions faster and with fewer errors. In our evaluation, physicians read VCM 1.8 times faster than text, and do 2.1 time less errors (significant difference with alpha=5%).

The invention may be used e.g., by any health professionals, such as physicians and pharmacists. It allows a clear representation of complex medical knowledge, and facilitates decision-making, diagnosis, prescription, and medical understanding, in order to fasten medical knowledge access, and reduce errors

### REFERENCES

[1] Elting L S, Bodey G P. Is a picture worth a thousand medical words? A randomized trial of reporting formats for medical research data. Methods of information in medicine 1991; 30:145-150.
[2] Bertin J. Semiology of graphics. University of Wisconsin Press; 1983.
[3] University of North Carolina at Chapel Hill Duke University. Optimizing patient comprehension through medicine information leaflets. United States Pharmacopeia; 1998. Http://www.uspdqi.org/pubs/other/PatientLeafletStudy.pdf
[4] Vigneron J, Gindre I, Daouphars M, Monfort P, Georget S, Chenot E, et al. Stabilis 2: an international CD-ROM database on stability and compatibility of injectable drugs. Journal of the European Association of Hospital Pharmacists (EJHP) 2004; (2):59-60.
[5] Chittaro L. Information visualization and its application to medicine. Artificial Intelligence in Medicine 2001; 22(2):81-88.
[6] Andrews K. Information visualisation: tutorial notes; 2002. Available from: http://www2.iicm.edu/ivis/ivis.pdf
[7] Chittaro L, Combi C, Trapasso G. Data Mining on Temporal Data: a Visual Approach and its Clinical Application to Hemodialysis. Journal of Visual Languages and Computing 2003; 14(6):591-620.
[8] Duclos C, Cartolano G L, Ghez M, Venot A. Structured representation of the pharmacodynamics section of the Summary of Product Characteristics for antibiotics: application for automated extraction and visualization of their antimicrobial activity spectra. Journal of the American Medical Informatics Association 2004; 11(4):285-293.
[9] Spenke M. Visualization and interactive analysis of blood parameters with InfoZoom. Artificial Intelligence in Medicine 2001; 22(2):159-172.
[10] Wroe C, Solomon W, Rector A, Rogers J. DOPAMINE: A Tool for Visualizing Clinical Properties of Generic Drugs. In: Proceedings of the Fifth Workshop on Intelligent Data Analysis in Medicine and Pharmacology (IDAMAP); 2000.
[11] Herman I, Melançon G, Marshall M S. Graph Visualization and Navigation in Information Visualization: A Survey. IEEE Transactions on Visualization and Computer Graphics 2000; 6(1):24-43.
[12] Ketan B. Using Treemaps to Visualize Gene Ontologies. Human Computer Interaction Lab and Institute for Systems Research. University of Maryland, College Park, Md. USA; 2001. Http://www.cs.umd.edu/hcil/treemap/GeneOntologyTreemap.pdf.

1. A method for graphical representation of medical knowledge, the method comprising using pictograms, colors, shapes and a grammar, thereby composing a language representing patient's current states, risks, antecedents, drug treatments and follow-ups.

2. The method of claim 1, wherein said method comprises the use of a distinct color to distinguish each of the following type of information: a patient current status (diseases, symptoms, physiological states, lifestyle), a risk, an antecedent, a drug, a follow-up procedure.

3. The method of claim 2, wherein the following colors are used:
in red, current patient states,
in orange, patient risks,
in brown, patient's antecedents,
in green, treatments,
in blue, medical follow-ups.

4. The method of claim 1, wherein said method uses pictograms to represent the various anatomico-functional relations.

5. The method of claim 4, wherein said method uses distinct pictograms to represent anatomical sites, such as heart, lung, kidney, intestine, skin and liver.

6. The method of claim 1, wherein said method comprises the use of distinct shapes to distinguish pathological and non-pathological states, and for pathological state, to precise the generic disorders of the pathology.

7. The method of claim 6, wherein the shapes further comprise a symbol, such as an arrow.

8. The method of claim 6, wherein etiologies are represented by an external agent entering into the shape.

9. The method of claim 6, which comprises using a shape as disclosed in FIG. 3.

10. The method of claim 1, wherein said method considers two aspects of patient states, an anatomico-functional localization and zero or more disorder occurring on the anatomico-functional localization, wherein disorders are divided into two categories: disorders specific to the anatomico-functional localization, and generic disorders, generic disorders being represented by an exterior shape and the anatomico-functional localization as well as localisation-specific disorders being represented by a pictogram inside the shape.

11. The method of claim 1, that represents a drug (or a patient under drug treatment) by reusing the same representation than the disease or the risk the drug treat, with an additional pictogram to say “treated by a drug”.

12. The method of claim 11, wherein said pictogram is a green cross.

13. The method of claim 1, that represents a follow-up procedure (or a patient followed-up) by the same representation than the disease, the risk or the physiological state (e.g. pregnancy) followed-up, with an additional pictogram to say “followed-up”.

14. A method for graphical representation of medical knowledge, wherein the grammar comprises sentences composed of three parts: the conditions for the sentence to be true, the statements, and the actions that the physician should do or not do.

15. The method of claim 14, wherein the conditions are separated from the statements and actions by (an) arrow(s).

16. The method of claim 14, wherein the actions are contained in a frame and the actions not to be taken are barred, and wherein logical operations AND and OR are represented as follows: a first level corresponding to AND by surrounding separately each element, a second level corresponding to OR by separating each elements by (a) vertical bar(s), a third level corresponding to AND by juxtaposing elements (which may be separated by a space).

17. A medical document, such as a drug dictionary or a medical record, wherein said medical document comprises a graphical representation of drugs' profile, said graphical representation comprising a set of pictograms, colors, shapes and a grammar to compose a language representing patient's current states (including diseases), risks, antecedents, drug treatments and follow-ups.

18. A method to index or summarize a medical document by a graphical stylised and schematized character, wherein said character is divided into several locations, each of them being dedicated to an anatomico-functional localisation or an etiology represented by a pictogram.

19. The method of claim 18, wherein the character further represents patient's current states (including diseases, risks, antecedents, drug treatments and follow-ups) and associated medical treatment (monitoring, drugs, etc), where applicable.

20. The method of claim 18, wherein generalization methods are being used where several patient states or treatments are to be represented for a same anatomico-functional localization or etiology.

21. The method of claim 18, wherein the character has the shape of a human body.

22. The method of claim 18, wherein the character has a “fixed position” for each anatomico-functional localisation or etiology, and when the medical document does not indicate any such anatomico-functional localisation or etiology, it is still represented, although in a different manner (e.g. grayed).

23. The method of claim 18, wherein the character is interactive, such that clicking on an icon gives access to parts of the medical document related to the anatomico-functional localisation or etiology.

24. A medical document, including a drug dictionary, or a medical record, wherein said medical document comprises a graphical character for indexing the document, as described by claim 1.

25. A search engine dedicated to medical documents, which displays the results of the search using the graphical representation of the documents or the medical aspects involved by the documents, such as the diseases a clinical guideline is devoted to, the graphical representation being the one described by claim 1.

26. A search engine dedicated to medical documents, which uses the graphical character described by claim 18 for entering information about the document searched.

27. A search engine dedicated to medical documents, which uses the graphical character described by claim 18 for displaying the results of the search.

28. A software system helping to browse a medical terminology, possibly in order to help the encoding of medical data into this medical terminology, and using the graphical representation described by claim 1 for representing the terminology's terms to the user.

29. A software system helping for browsing a medical terminology, possibly in order to help the encoding of medical data into that medical terminology, and which uses the graphical character described by claim 18.

30. The application described in claim 24, on a PDA (Personal Digital Assistant).
